(19) United States
(12) Patent Application Publication
(10) Pub. No.: US 2022/0116552 A1
(43) Pub. Date: Apr. 14, 2022

(54) System and/or Method for Enhancing Content in Live Streaming Video

(71) Applicant: VIDIPLUS, LTD, Yokneam (IL)

(72) Inventor: Dror Benjamin, Alonei Aba (IL)

(21) Appl. No.: 17/495,671

(22) Filed: Oct. 6, 2021

Related U.S. Application Data
(60) Provisional application No. 63/089,354, filed on Oct. 8, 2020.

(51) Int. Cl. H04N 5/272; G06F 3/0486; H04L 29/06

(52) U.S. Cl. CPC H04N 5/272; H04L 65/403; G06F 3/0486

(57) ABSTRACT

A computer system is configured to integrate virtual content with a live streaming video in substantially real time. In particular, the computer system is configured to receive a stream of camera-generated video from a hardware camera. The computer system is also configured to obtain virtual content from a multimedia file. The virtual content is then integrated into the stream of the camera-generated video to generate an integrated stream of video in substantially real time. Integrating the virtual content into the stream of the camera-generated video comprises integrating each frame of the virtual content into each frame of the stream of the camera-generated video in substantially real time.

### CROSS-REFERENCE TO RELATED APPLICATION

This application claims the benefit of U.S. Provisional Application No. 63/089,354, filed Oct. 8, 2020, the entire contents of which are herein incorporated by reference.

### TECHNICAL FIELD

Embodiments of the invention relate to a system and method for enhancing camera-generated content in substantially real time, including integrating virtual content into camera-generated content in substantially real time.

### BACKGROUND

Web conferencing relates to various types of online conferencing, such as video streaming, where a full-motion webcam, digital video camera, or multimedia files can be pushed to audiences online.

Software programs are available for enabling the various types of web conferencing, such as online video meeting platforms that include technologies for the reception and transmission of audio-video signals by users at different locations.

Web conferencing is used by various types of individuals and entities to achieve different communication objectives. For example, web conferencing software may be used by one individual for personal communication, while another user or entity may utilize it for professional communication. In professional settings, web conferencing software requires features capable of supporting typical business practices, such as conferencing with multiple individuals and presenting sales pitches. As such, the software should support streamlined communication between all participants, be user-friendly, and provide an engaging experience in order to serve as an effective equivalent to in-person meetings.

Many businesses rely on web conferencing software for telecommuting employees and to connect with clients; and because of this, there have been significant advancements in web conferencing software. However, the programs available are either too simplistic, do not provide adequate features for an effective conference or presentation, or they are too complex and require advanced computer skills to execute a presentation. Cumbersome web conferencing software requiring many actions to complete a single action can unnecessarily extend the length of a meeting or sales pitch and cause the presenter to lose the attention of their audience.

Furthermore, not all professionals are computer savvy, and complicated web conferencing software can cause these professionals to become frustrated and fail to conduct effective meetings or presentations. This frustration can also be exacerbated by web conferencing software that is not enabled to operate on screens of varying sizes which can also detract from the objective of a presentation.

Accordingly, a need exists for web conferencing software that can provide for an effective, high-quality presentation with a user-friendly interface.

### SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

The principles described herein are related to a computer system and/or a method for real-time merging virtual content with a live streaming video, which provides virtual camera solutions for integrating virtual content into camera-generated video in substantially real time.

The computer system is configured to receive a stream of a camera-generated video from a hardware camera and receive virtual content from a multimedia file. The computer system then integrates virtual content into the stream of the camera-generated video. In particular, integrating virtual content into the stream of the camera-generated video includes integrating each frame of virtual content into each frame of the stream of the camera-generated video in substantially real time.

In some embodiments, integrating each frame of virtual content into each frame of the stream of the camera-generated video includes, for each frame of the stream of the camera-generated video and each frame of virtual content, the computer system receives the frame of the stream of the camera-generated video from the hardware camera, receiving the frame of virtual content from the multimedia file, integrate the frame of virtual content into the frame of the stream of the camera-generated video to generate an integrated frame of video, and display and/or transmit the integrated frame of video in substantially real time.

In some embodiments, the computer system is further configured to display a graphical user interface (GUI) (also referred to as a first GUI), including a plurality of controls configured to control the integration of virtual content and the stream of the camera-generated video. For example, in some embodiments, the plurality of controls are configured to adjust a size, a location, and/or an angle of rotation of the virtual content relative to the stream of the camera-generated video.

In some embodiments, the computer system is further configured to display a second GUI configured to display the stream of the camera-generated video, virtual content, and/or the integrated stream of video. The first GUI includes a floating widget that is separate from the second GUI.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter

### BRIEF DESCRIPTION OF THE FIGURES

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIG. 1 schematically shows a flow diagram illustrating various possible components of a system and/or method for enhancing content in web conferencing in accordance with an embodiment of the present invention;

FIG. 2 illustrates an example process of integrating virtual content into each frame of a stream of camera-generated video;

FIG. 3 illustrates an example software architecture that may be implemented in a control application described herein;

FIGS. 4 and 5 schematically illustrate stages of launching a software program of a control application in accordance with an embodiment of the present invention that can be part of a system for enhancing content;

FIG. 6 illustrates an example data structure of a project described herein;

FIGS. 7A-7G illustrate examples of a graphical user interface or a toolbar of the control application described herein;

FIG. 7H illustrates an example icon of the control application described herein;

FIGS. 8A-8D illustrate example thumbnails corresponding to different types of content items, on which different sets of controls are superimposed thereon;

FIGS. 9A and 9B illustrate an example process of using controls superimposed on a thumbnail to integrate the virtual content into a stream of camera-generated video generated by a hardware camera;

FIGS. 10A and 10B illustrates a GUI of the control application in accordance with an embodiment of the present invention, configured to mirror a stream of camera-generated video generated by the camera;

FIGS. 11A-11D illustrate example GUIs for using the principles described herein in a web conferencing session;

FIGS. 12A-12E illustrate additional example GUIs of the control application;

FIG. 13 illustrates an example GUI that allows a user to drag a multimedia file into a visualization to add an image item, a video item, an image presentation item, and/or a 3D sequence;

FIG. 14 illustrates a flowchart of an example method for real-time enhancing a live streaming video with virtual content; and

FIG. 15 illustrates a flowchart of an example method for integrating each frame of virtual content into each frame of the stream of the camera-generated video generated by a hardware camera.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

The principles described herein are related to a computer system and/or a method for real-time enhancing a live streamlining video with virtual content, providing virtual camera solutions for integrating virtual content into live content generated by a camera in substantially real time.

In certain embodiments, the present disclosure includes embedding augmented reality (AR) content on a camera feed of a computer system. The present invention may be implemented at a video recording application and/or an online video meeting platform and/or as an add-on software that makes video meetings more interactive.

In at least certain embodiments, the present disclosure may be defined as relating to a software solution that allows users of an online video meeting software to show and share visual content, and additional visual aids in the same frame where they appear in a video call.

Visual content that can be shown may include: Share Screen, Images, PNG Sequence, Video, 3D models and/or Presentation (or the like).

The present disclosure thus in its various embodiments may be seen as facilitating video conferencing recording/conferencing solutions that allow for sharing visual content while possibly maintaining the following: only one call participant can present visual content at a time, user can choose in advance the visual content items and their sequence to be shown, provision of the ability to interact with the visual content live, keeping all video call participants the same size while presenting (etc.).

The present disclosure in at least certain embodiments may enable a presenter to see himself/herself and what the presenter is sharing on the screen.

Users may be able to retain their original image size on-call participants' screens, while also adding visual aids to the conversation and interacting with them, to thereby provide a type of service that can be highly beneficial in the fields of sales, teaching, webinars, customer service (and the like).

In at least certain embodiments, the present disclosure may be defined as relating to a software solution that adds (embeds) an additional visual layer on the user's video feed (which is used by the video chat software as the direct video feed from that user).

The combination of the live camera feed with the additional visual layer may in certain embodiments, result in an upgraded video feed. Such a new feed may allow in certain cases the presenter to share visual aids which were prepared in advance and possibly in a specific sequence of order.

Visual content may be presented alongside a presenters' own image, and a presenter may control the size of both his own image, and the visual content that he presents. Possibly, the aforementioned may be performed while permitting all video chat participants to remain the same size and for the presenter to see himself.

In addition, the presenter may be arranged to see himself in large on the screen, and see how he interacts with the content.

In at least most embodiments, the presently provided solution may be arranged to be built in layers.

A stream coordination center (SCC) may be a component responsible for receiving and/or merging different stream processor elements and merging them into a single video stream in real-time.

A stream coordination center (SCC) in certain embodiments may be adapted via stream processing to produce a virtual operating system (OS) camera.

Stream processing, in certain cases, may be able to take some inputs and convert the same into a video stream. Available stream processors may include the following Stream Elements: Physical camera display (e.g., webcam), Image file (e.g., png, gif, etc.), Video file (e.g., mp4), presentation file (e.g., PowerPoint), text entered via a keyboard, a screen of another application or window view, a mobile display.

A controller, according to various embodiments of the present disclosure, may be a user interface arranged for controlling the processed virtual content items to deliver them as a merged video stream to the virtual camera.

Such control user interface may be “always on” to allow a user to send commands to manipulate the streams without leaving their current view (e.g., a 3rd party video conferencing system).

Command example possibly controllable by such a control user interface may be any one of the following: resize and reposition stream element in the stream, Zoom in/out, Display/hide a stream element, Activate a Stream processor element (e.g., play video, or advance to next slide) (or the like).

In addition to the exemplary aspects and embodiments described above, further aspects and embodiments will become apparent by reference to the figures and by a study of the following detailed descriptions.

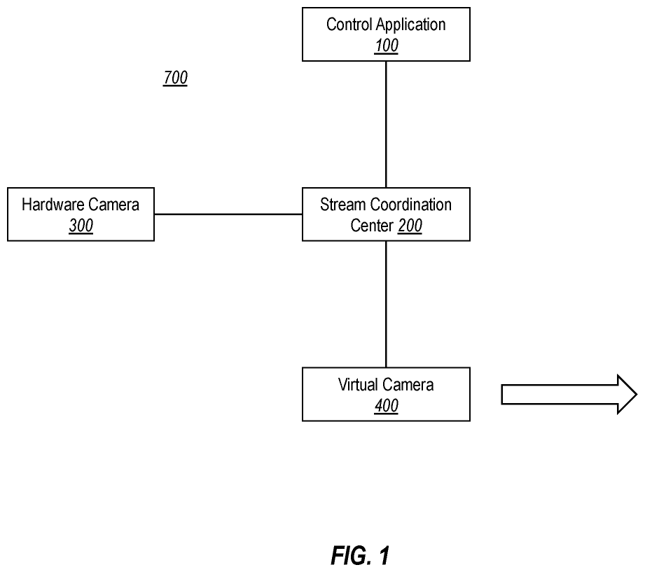

FIG. 1 schematically illustrates an example of a computer system 700 that implements the principles described herein. As illustrated, the computer system 700 includes a control application 100, a stream coordination center (SCC) 200, and a hardware camera 300. The hardware camera 300 is configured to take videos of a physical environment to generate a stream of camera-generated video. The SCC 200 is configured to receive the stream of the camera-generated video from the hardware camera and integrate virtual content into the stream of the camera-generated video to generate an integrated stream of video, which forms a virtual camera 400. The control application 100 is configured to control the integration of virtual content into the stream of the camera-generated video. For example, in some embodiments, the control application 100 allows a user to adjust a size or a location of virtual content relative to the stream of the camera-generated video. In some embodiments, the output of virtual camera 400 may be used as an input of another application, such as (but not limited to) a video recording application, a network conference application, etc. Alternatively, the virtual camera 400 may be integrated into another application as an add-on or an integrated component.

A video stream is a sequence of images. Each of the sequence of images is also referred to as a “frame.” In some embodiments, integrating virtual content into the stream of the camera-generated video includes integrating each frame of virtual content into each frame of the stream of the camera-generated video in substantially real time.

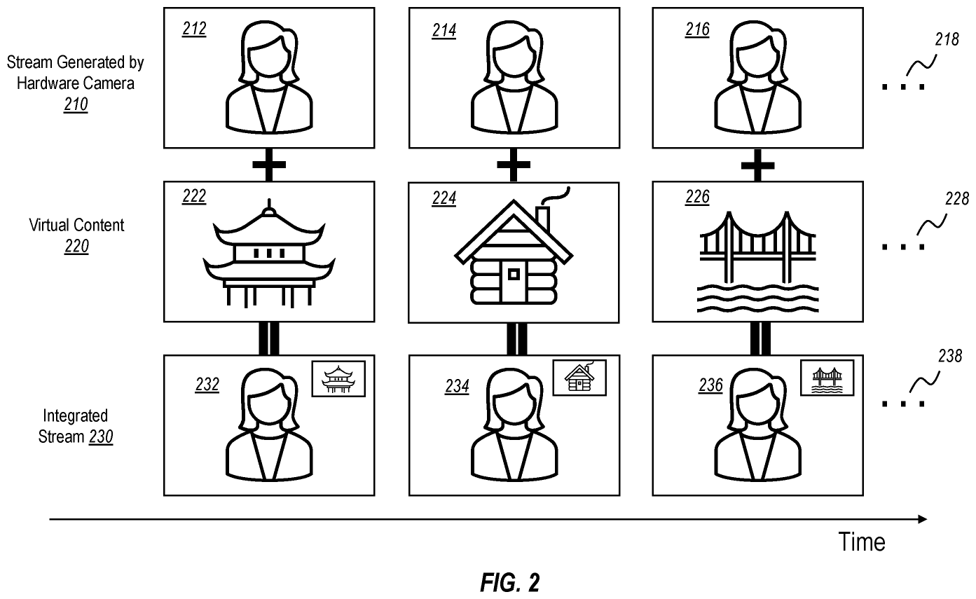

In some embodiments, integrating virtual content into the stream of the camera-generated video includes integrating one or more frames of virtual content into one or more frames of the stream of the camera-generated video. FIG. 2 illustrates an example process of integrating virtual content 220 into each frame of a stream of camera-generated video 210 to generate an integrated stream of video 230. A stream of camera-generated video is a sequence of images, each of which is a frame. As illustrated in FIG. 2, a stream of camera-generated video 210 (generated by the hardware camera 300) includes a first sequence of frames 212, 214, 216; and virtual content 220 includes a second sequence of frames 222, 214, 216. The arrowed line represents a time axis. Each frame of virtual content 220 is integrated into a corresponding frame of the stream of the camera-generated video 210. For example, the first frame 222 of virtual content 220 is integrated into the first frame 212 of the stream of the camera-generated video 210 to generate a first integrated frame 232; the second frame 224 of virtual content 220 is integrated into the second frame 214 of the stream of the camera-generated video 210 to generate a second integrated frame 234; and the third frame 226 of virtual content 220 is integrated into the third frame 216 of the stream of the camera-generated video 210 to generate a third integrated frame 236; and so on and so forth. The ellipsis 218, 228, 238 represent that there may be any number of frames in the stream of the camera-generated video or virtual content.

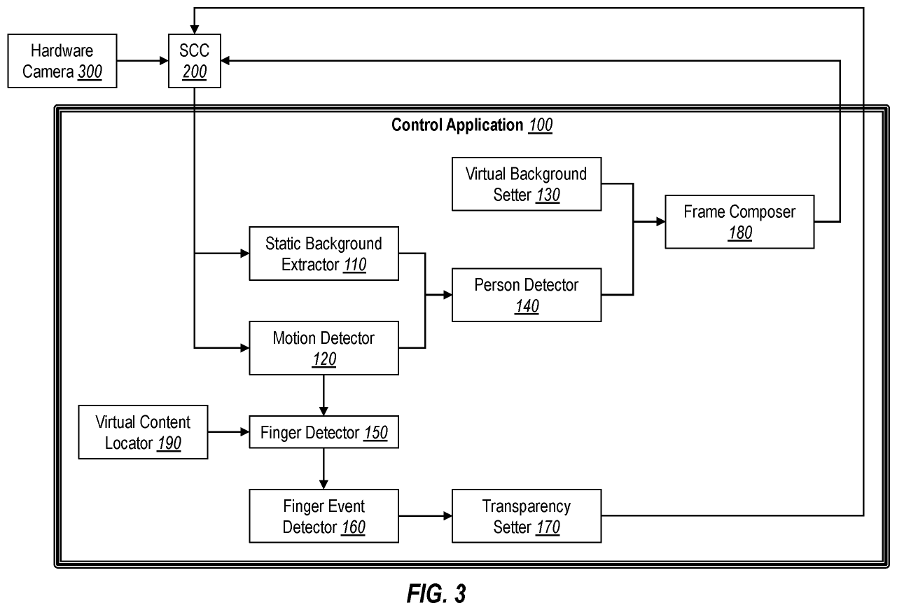

FIG. 3 illustrates an example software architecture that may be implemented in the control application 100 and/or the SCC 200 (see FIG. 1). As illustrated in FIG. 3, a hardware camera 300 (which corresponds to the hardware camera 300 of FIG. 1) is configured to generate a stream of camera-generated video. SCC 200 (which corresponds to the SCC 200 of FIG. 1) is configured to receive the stream of the camera-generated video (generated by the hardware camera 300) and integrate virtual content into the stream of the camera-generated video to generate an integrated stream of video.

In some embodiments, the control application 100 includes a static background extractor 110 configured to extract static background from each frame. In some embodiments, the control application 100 also includes a motion detector 120 configured to detect a moving object in the frames. In some embodiments, the control application 100 also includes a person detector 140 configured to detect a person pixel mask area where a person is positioned. In some embodiments, the person detector 140 detects a person partially based on the results of the static background extractor 110 and the motion detector 120. For example, in some embodiments, the person detector 140 further processes an image with static background removed and/or an area in which motion has been detected. In some embodiments, the person detector 140 is configured to identify a shape of a moving object and determine whether the moving object is a person based on the shape.

In some embodiments, the control application 100 also includes a finger detector 150 configured to detect a finger of a person. During a video conference, a user may use hand gestures and/or point at virtual content. A virtual content locator 190 is configured to identify an area where the virtual content is integrated into the stream of the camera-generated video. When the virtual content is displayed on top of the user (including the user's hand) in the video stream, the virtual content will block the user's hand. To allow the hand and the virtual content to be seen, in some embodiments, the control application 100 also includes a finger event detector 160 and a transparency setter 170. The finger event detector 160 is configured to detect a finger event, in which a user's finger moves into an area where the virtual content is displayed. In response to detecting a finger event, the transparency setter 170 is configured to set a transparency value of the virtual content, causing the virtue content to be displayed as semi-transparent content.

In some embodiments, the control application 100 also includes a virtual background setter 130 and a frame composer 180. The virtual background setter 130 is configured to set a virtual background for the stream of the camera-generated video (generated by the hardware camera 300). The frame composer 180 is configured to replace the static background of the stream of the camera-generated video with the virtual background set by the virtual background setter 130. In some embodiments, the virtual background setter 130 may be configured to set a virtual background based on a user indication. In some embodiments, the virtual background setter 130 may be configured to process the static background to transform the static background to a virtual background. For example, the transformation may include blurring the background, changing a color of the background, mirroring, rotating, and/or flipping the frames of video, etc.

The results of the transparency setter 170 and the frame composer 180 are then sent to SCC 200. The result of the frame composer 180 includes processed frames of stream of camera-generated video (generated by the hardware camera 300) and processed by the frame composer 180, which may or may not replace the real background with a virtual background. The result of the transparency setter 170 includes processed frames of virtual content generated by the virtual camera 400 and processed by the transparency setter 170, which may or may not set the images to be semi-transparent. Based on the frames received from the transparency setter 170 and the frame composer 180, SCC 200 is configured to generate integrated frames of video that integrate the processed frames of stream of camera-generated video with virtual content.

Note, in some embodiments, a person detector 140, virtual background setter 130, and/or a frame composer 180 may also be configured to identify a person in the virtual content and/or replace the background of the virtual content with a virtual background.

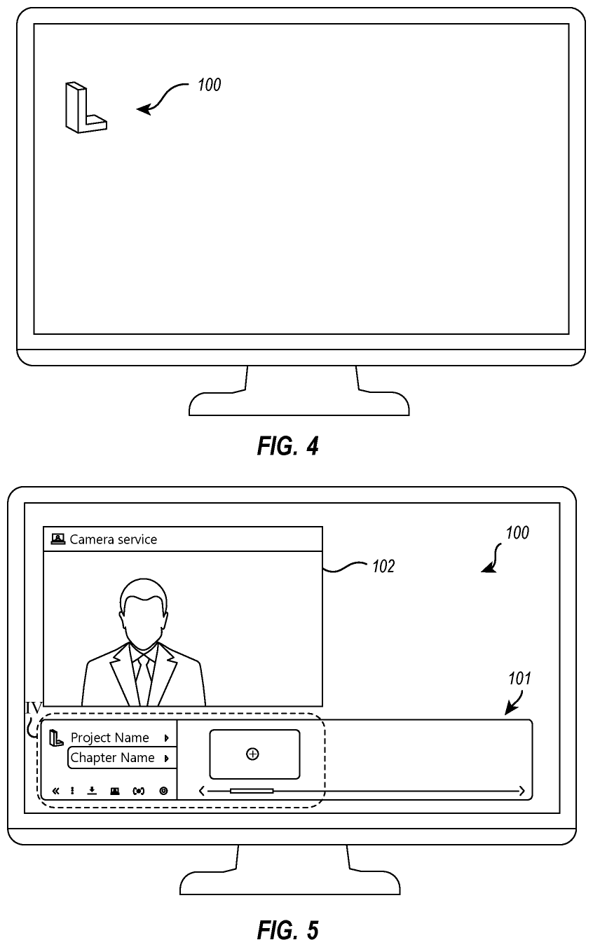

In some embodiments, the control application 100 is compiled into an executable software program. When the control application 100 is executed at a computer system, a graphical user interface (GUI) (also referred to as a first GUI) is shown on display. FIG. 4 illustrates an icon of a software program of the control application 100. When the icon of the software is clicked by a user, the control application 100 is executed. FIG. 5 illustrates an example GUI 101 of the control application. In some embodiments, the GUI 101 includes a plurality of controls that are configured to interact with users.

In some embodiments, the control application 100 also presents a second GUI 102 configured to allow a user to preview the stream of the camera-generated video, the virtual content, and/or the integrated stream of video. For example, in some embodiments, the second GUI 102 includes a visualization configured to display the stream of the camera-generated video taken by the hardware camera 300, virtual content, and/or the integrated stream of video. As shown in FIG. 3, the second GUI 102 displays the stream of the camera-generated video, in which a user is sitting in front of the hardware camera. Such a type of videos taken by hardware cameras are common when video conferences are conducted.

In some embodiments, the control application 100 is configured to obtain virtual content from a multimedia file. In some embodiments, the multimedia file includes one of an image file, a video file, a text file, a presentation file (e.g., a PowerPoint file), a three-dimensional (3D) file, and/or a web page. In some embodiments, obtaining the virtual content includes opening the multimedia file via a content viewing application, and generating virtual content includes extracting a sequence of images from the content viewing application at a predetermined frequency.

In some embodiments, the first GUI 101 is a floating widget or toolbar that is separate from the second GUI 102 configured to display the stream of the camera-generated video (generated by the hardware camera 300), virtual content, and/or the integrated stream of video. It is advantageous to implement a floating widget as the first GUI 101, such that the widget can be freely moved within the display without interfering with the second GUI 102 that displays the stream of the camera-generated video, the virtual content, or the integrated video generated by the virtual camera 400.

In some embodiments, in response to integrating virtual content into the stream of the camera-generated video, the computer system 700 is configured to display the stream of the camera-generated video integrated with virtual content in the second GUI 102 associated with the hardware camera 300. This integrated video stream can then be recorded in a video file and/or transmitted outwards from system 700, for example, as a video stream of a presenter in a web conferencing session.

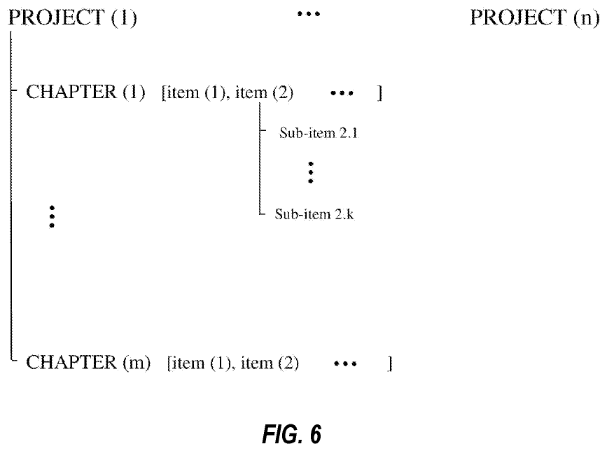

In some embodiments, a user can organize and save different virtual contents into projects. In some embodiments, each project has a tree data structure. FIG. 6 illustrates an example data structure of a project. As illustrated, in some embodiments, each project includes one or more (m) chapters, where m is a natural number. Each chapter includes one or more items, and each item includes one or more sub-items. A user can create any number (n) projects, where n is a natural number. There are multiple types of items that may be included in a chapter of a project, such as (but not limited to) an image, an image presentation, a video, an image sequence, a 3D object, etc.

In some embodiments, each item corresponds to one or more multimedia files, which contain virtual content that is to be integrated in the stream of the camera-generated video (generated by the hardware camera 300). Each multimedia file corresponds to a uniform resource locator (URL) or a path associated with a location where the multimedia file is stored. The project (or a project file) is configured to store a URL or a path corresponding to the multimedia file in an item. In some embodiments, an item may correspond to multiple multimedia files, each of which corresponds to a sub-item. Each item or sub-item is associated with one or more settings and their corresponding parameters. For example, such a setting may be (but is not limited to) a position of the virtual content relative to the stream of the camera-generated video (generated by the hardware camera 300), a transparency level of the virtual content, and/or an angle of rotation of the virtual content.

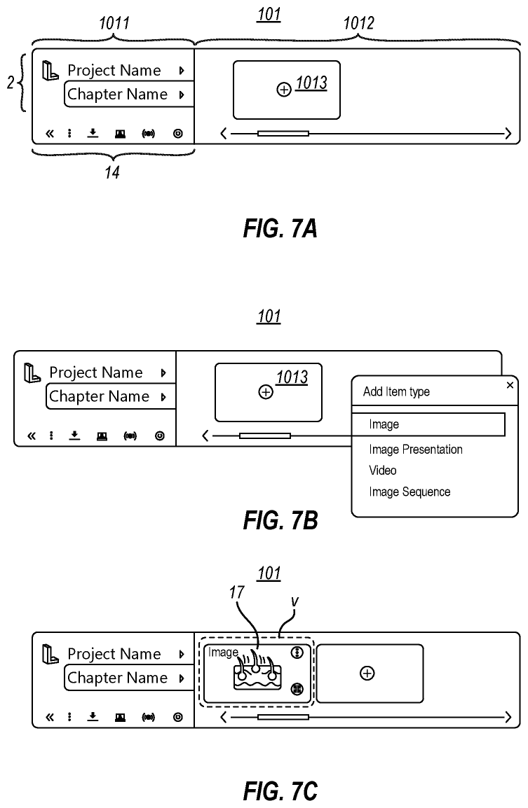

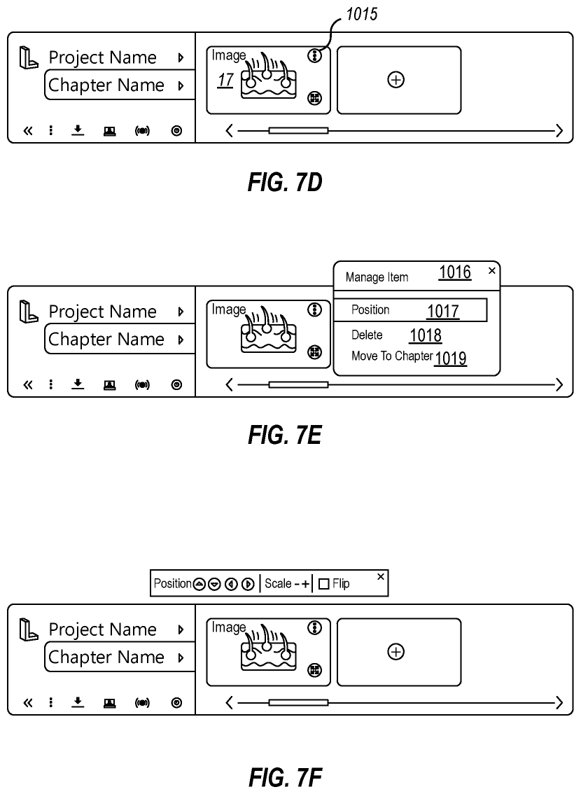

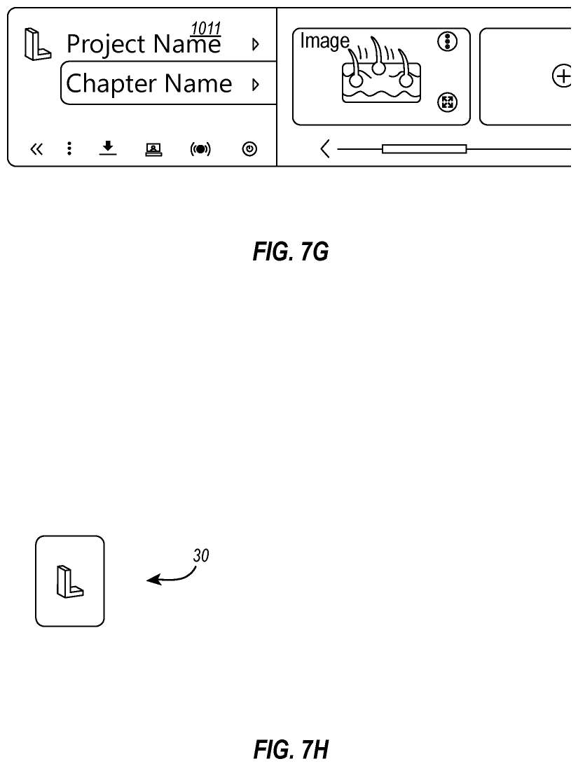

In some embodiments, the first GUI 101 is configured to allow a user to generate new projects and review previously saved projects. FIGS. 7A-7G illustrate examples of the first GUI 101, including a command section 1011 and an item section 1012. As illustrated in FIGS. 7A-7F, the command section 1011 allows a user to create new projects, and add new chapters to each project. The item section 1012 allows a user to add new items to the chapter. As illustrated, the item section 1012 includes an icon 1013 for adding a new item. When a user clicks the icon 1013, a menu 1014 pops up. The menu 1014 has a list of types of items that a user can select, such as (but not limited to) an image, an image presentation, a video, an image sequence, etc. Once a new item is added to the chapter, a thumbnail image corresponding to the new item is generated and listed in the item section 1012.

FIGS. 7D-7F further illustrate examples of the first GUI 101 that allows a user to modify or delete existing items. As illustrated in FIGS. 7D-7F, the thumbnail 17 includes a menu control 1015 at its top-right corner. When the menu control 1015 is clicked or selected, a menu 1016 pops up. The menu 1016 includes (but is not limited to) a position control 1017, a delete control 1018, and a move to chapter control 1019. The position control 1017 allows a user to adjust a position of the virtual item relative to the stream of the camera-generated video (generated by the hardware camera). As shown in FIG. 7F, when the position control 1017 is selected, another menu 1020 pops up. The menu 1020 includes additional controls that allow the user to (1) move the virtual content up and down, and/or left and right, (2) to scale the virtual content larger or smaller, and/or (3) perform one or more transformations to the virtual content (such as, but not limited to, flip the virtual content). The delete control 1018 allows a user to delete the item. The move to chapter control 1019 allows the user to move the item to a different chapter.

Once a user (such a presenter) has finalized preparing his/her project or presentation, he/she may choose to give the item, the chapter, and/or the project a name, and save the project on a hard drive of the computer system. FIG. 7G illustrates an enlarged view of the command section 1011, via which a user can name and save the project and/or chapter. FIG. 7H illustrates that the toolbar or the first GUI of the control application can be minimized to a small icon 30 that substantially does not interfere with other software windows open on the user's computer screen.

Further, as illustrated in FIGS. 7A-7G, a set of controls are superimposed on each thumbnail 17 of items for controlling the display of the item. Different types of controls may be implemented for different types of items. As such, a different set of controls may be superimposed on different thumbnails corresponding to different types of items.

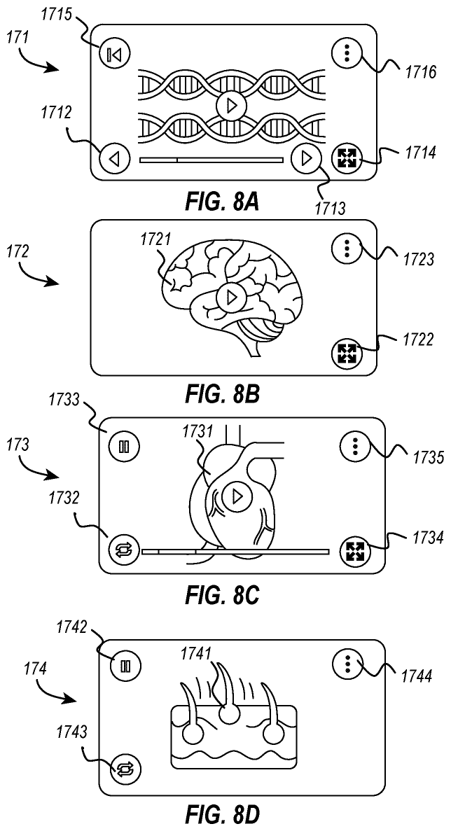

FIGS. 8A-8D illustrate several different thumbnails corresponding to different types of items, having different sets of controls superimposed thereon. FIG. 8A illustrates a thumbnail 171 corresponding to an image presentation item. A set of video controls 1711-1716 are superimposed on the thumbnail 171. The set of image presentation controls 1711-1716 include (but are not limited to) a play control 1711 at the center, a backward control 1712 and a forward control 1713 at a bottom left corner and a bottom right corner, a backward to start control 1714 at a top left corner, a full screen control 1715 at a bottom right corner, and a menu control 1716 at a top right corner.

FIG. 8B illustrates a thumbnail 172 corresponding to an image item. A set of image controls 1721-1723 are superimposed on the thumbnail 172. The set of image controls 1721-1723 includes (but are not limited to) a play control 1721 at the center of the thumbnail 172, a full-screen control 1722 at a bottom right corner, and a menu control 1723 at a top right corner.

FIG. 8C illustrates a thumbnail 173 corresponding to a video item. A set of video controls 1731-1736 are superimposed on the thumbnail 173. The set of video controls 1731-1735 includes (but are not limited to) a play control 1731 at the center, a replay control 1732 at a bottom left corner, a full-screen control at the bottom right corner, a stop control 1733 at a top left corner, a full screen control 1734 at a bottom right corner, and a menu control 1735 at a top right corner.

FIG. 8D illustrates a thumbnail 174 corresponding to an image sequence item. A set of image sequence controls 1741-1744 are superimposed on the thumbnail 174. The set of image sequence controls 1741-1744 includes (but are not limited to) a play control 1741 at the center, a stop control 1742 at an upper left corner, a replay control at a bottom left corner 1743, and a menu control 1744 at a top right corner.

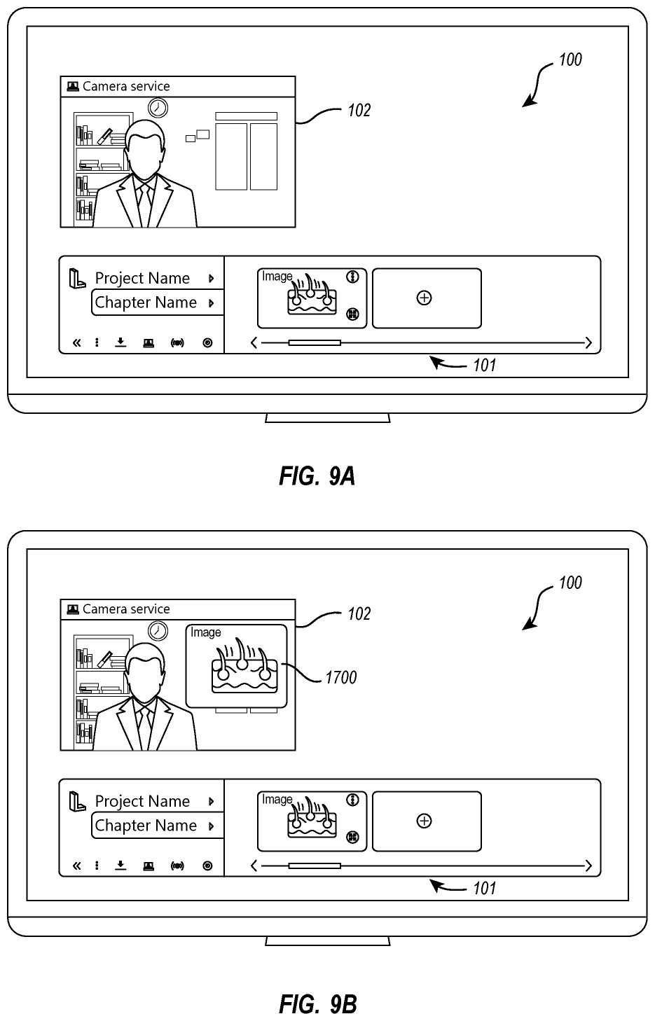

FIGS. 9A and 9B further illustrate an example process of using controls superimposed on the thumbnail 17 in the first GUI 101 to integrate the virtual content into the stream of the camera-generated video shown in the second GUI 102. In FIG. 9A, the second GUI 102 can be seen displaying video content generated by the hardware camera 300.

FIG. 9B shows that virtual content corresponding to a chosen content item is merged into the stream of the camera-generated video. Virtual content 1700 corresponding to the chosen content item(s) is integrated into the stream of the camera-generated video (generated by the hardware camera 300) to form an integrated stream of video that is displayed to the presenter in the second GUI 102, which may be a preview window. As illustrated, the virtual content 1700 corresponding to the chosen content item is overlaid on the video stream of the hardware camera may be formed by activating one set of the controllers superimposed on a thumbnail in item section 1012 of the first GUI 101. The activation of the virtual content (such as the virtual content corresponding to thumbnails 171-174 in FIG. 8A to 8D) may be performed by clicking the play/stop controls at its center or corner.

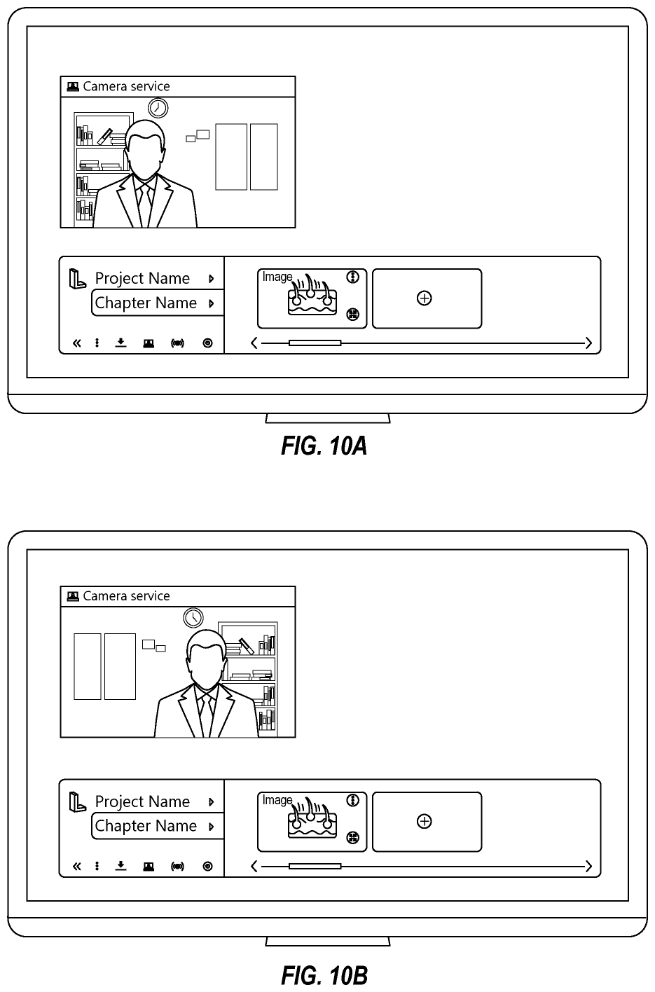

FIGS. 10A and 10B further exemplify possible mirroring of the stream of the camera-generated video (generated by the hardware camera 300) as displayed in the second GUI or a preview window 102. Such mirroring may assist the presenter in correctly orienting himself/herself as viewed in preview window 102 relative to virtual content 1700 overlaid on top of his/her image. Typically, a video stream arriving from the hardware camera may be a mirror image of the actual subject being recorded. For example, if a user were to raise his/her right hand, the preview window 102 may appear to the user as raising his/her left hand. Since the aim of the presently disclosed system is to assist in presenting and relating to virtual content, the presenter may choose to see himself/herself in a non-mirrored state in order to be able to relate (e.g., point at) more easily and accurately to the virtual content being presented.

In some embodiments, the control application 100 may be a standalone virtual camera application that can be used accompanying other applications. In some embodiments, the control application 100 may be integrated into a web conference application, a presentation application, and/or be integrated into a video recording application.

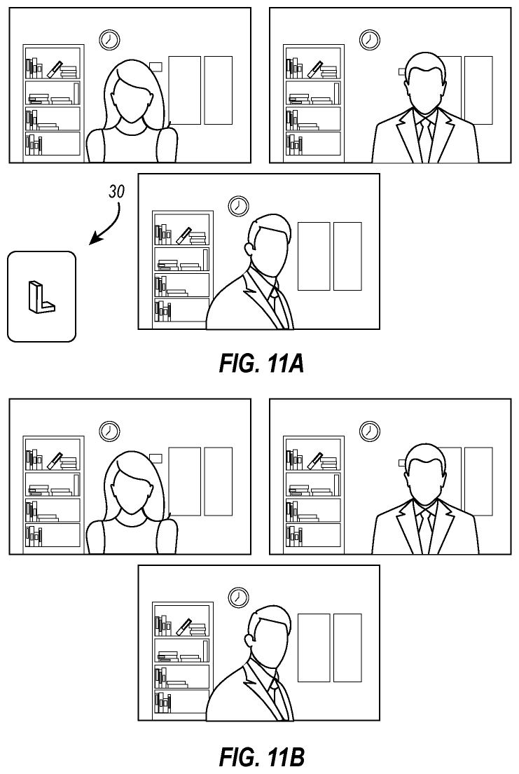

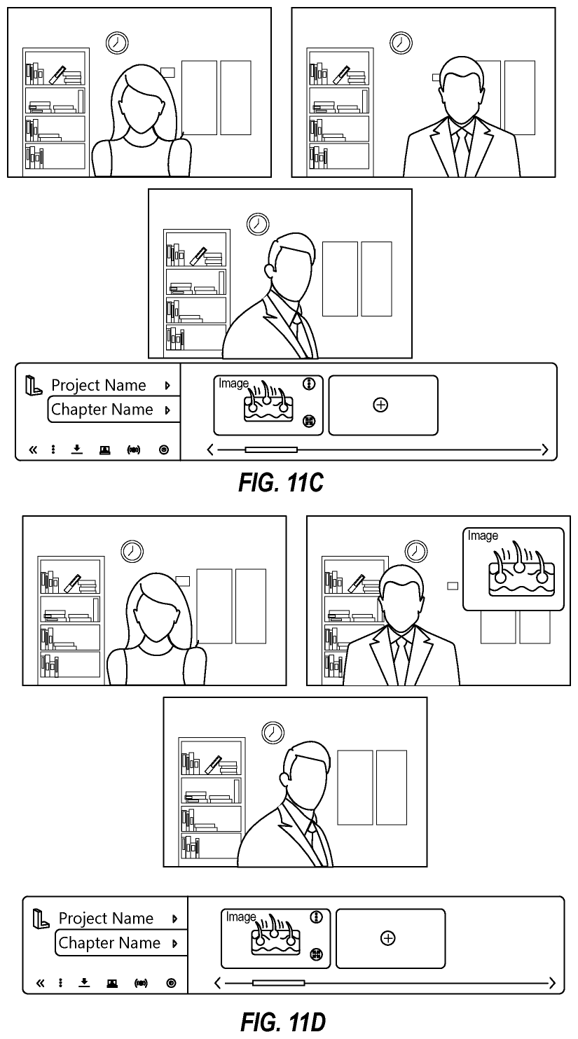

FIGS. 11A-11D further illustrate a possible use of an embodiment of a system 700 of the present disclosure during a web conferencing session. FIGS. 11A and 11B illustrate, respectively, a computer screen of the presenter and of an attendee of a web conferencing session. As seen in FIG. 11A, the presenter's screen in this example includes the small icon 30 of the toolbar ready for use, while icon 30 as seen in FIG. 11B is not visible in the views available to the attendees of the web conferencing session. In this example, the presenter can be seen in the upper-right view, while the attendees can be seen in the upper left and bottom views.

FIG. 11C illustrates the presenter's computer screen after the toolbar has been expanded to possibly reveal a pre-prepared presentation in the command section 1011 and item section 1012. FIG. 11D also illustrates the presenter's computer screen, however now with virtual content appearing in the presenter's view in the web conferencing session.

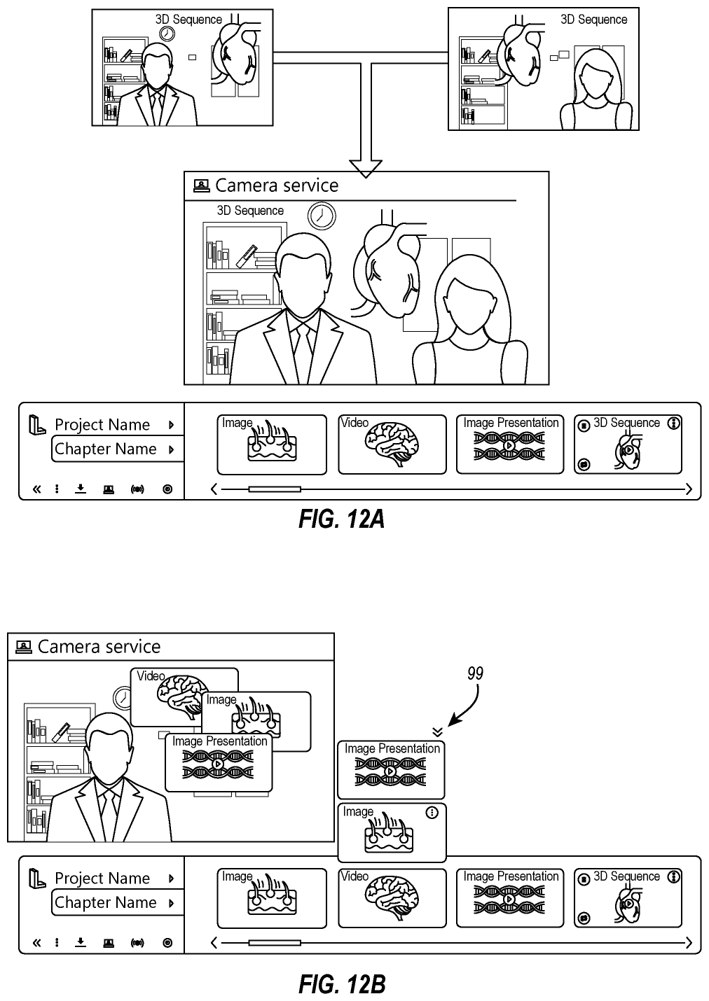

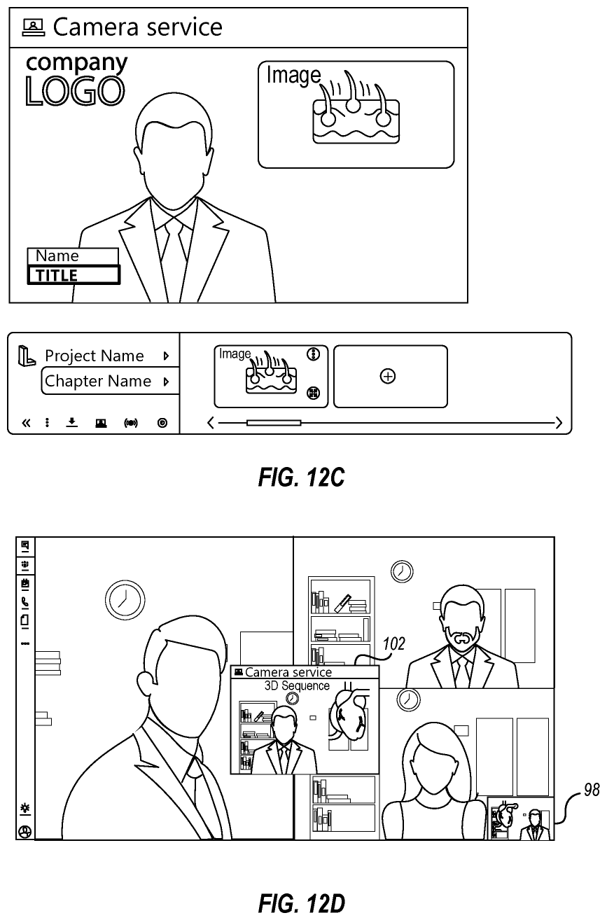

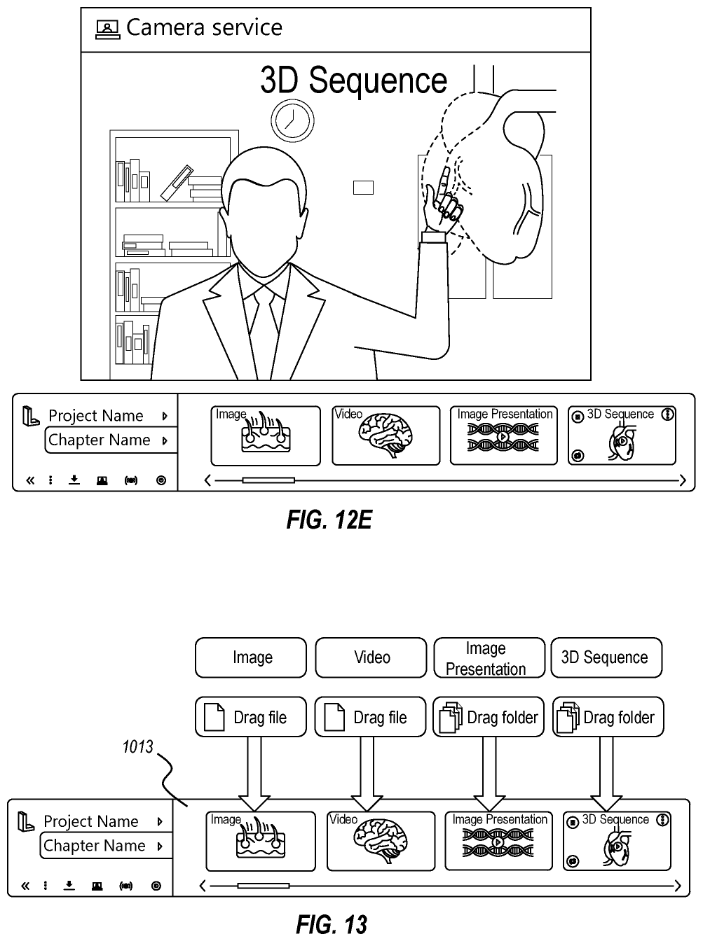

FIGS. 12A-12E further illustrate various control application embodiments, exemplifying various aspects of the present invention.

FIG. 12A schematically shows an option of a joint presentation by several presenters (here two) that are located at different locations.

FIG. 12B schematically shows a control application 100 with content items organized in the item section 1012 in a library formation generally similar to that presented in FIG. 6 where one of the content items is seen including sub-items. Here, the formation of such sub-items can be seen being visually displayed by placing players of these sub-items one above the other. In FIG. 12B the sub-items are in a visible state, and these sub-items can be collapsed in this example by pressing selection menu 99.

FIG. 12C exemplifies a possible presentation of additional virtual content within virtual camera 400 that possibly does not originate from content items available within item section 1012. In this example, a presenter may add virtual content such his/her name and/or company logo. Company branding and logos, and presentation title can be added in real-time to enhance the look and feel of the presentation.

FIG. 12D exemplifies a presentation using a web-conferencing application that is programmed to show the presenter to himself/herself in a relatively small window 98 while he/she is presenting. Since such viewing window 98 may be too small for the presenter to clearly see himself/herself, let alone interact with virtual content displayed in the same view, preview window 102 may be used by the presenter in such cases to better see himself/herself and interact with the virtual content being presented in the window. The presenter is allowed to view themselves giving the presentation on a larger screen, such that the presented is able to effectively interact with virtual content items displayed on the screen during the presentation and to orient themselves accordingly.

FIG. 12E exemplifies that when a person in a stream of camera-generated video moves and points their finger at the virtual content, the finger detector 150 (shown in FIG. 2) is configured to identify their finger. When the user's finger reaches an area where the virtual content is displayed, the finger event detector 160 (shown in FIG. 2) is configured to detect a finger event. In response to detecting the finger event, at least a portion of the virtual content (shown as a dotted line in FIG. 12E) is displayed as semi-transparent, such that the user's finger and the virtual content are at least partially visible to users.

FIG. 13 illustrates an example GUI of the control application that allows a user to drag a multimedia file into a visualization of the GUI to add an image item, a video item, an image presentation item, and/or a 3D sequence. As illustrated, a user can simply drag each of an image file, a video file, an image presentation file, and/or a 3D file into the item section 1012 to create a new item. In response to dragging a file into the item section 1012, the control application 100 is configured to generate a thumbnail corresponding to the file and display the thumbnail in the item section 1012. The control application 100 is also configured to link a URL and/or a path of the file to the thumbnail. When a user clicks a play control superimposed on the thumbnail, the control application 100 accesses the file via the URL and/or the path of the file to generate the virtual content.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

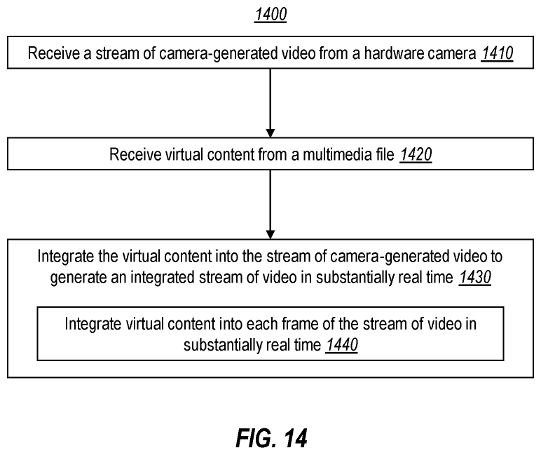

FIG. 14 is a flowchart of an example method 1400 for real-time enhancing a live streamlining video with virtual content. The method 1400 includes receiving a stream of camera-generated video from a hardware camera (act 1410), receiving virtual content from a multimedia file (act 1420), and integrating virtual content into the stream of the camera-generated video to generate an integrated stream of video in substantially real time (act 1430). The act 1430 of integrating virtual content into the stream of the camera-generated video includes integrating each frame of virtual content into each frame of the stream of the camera-generated video (act 1440).

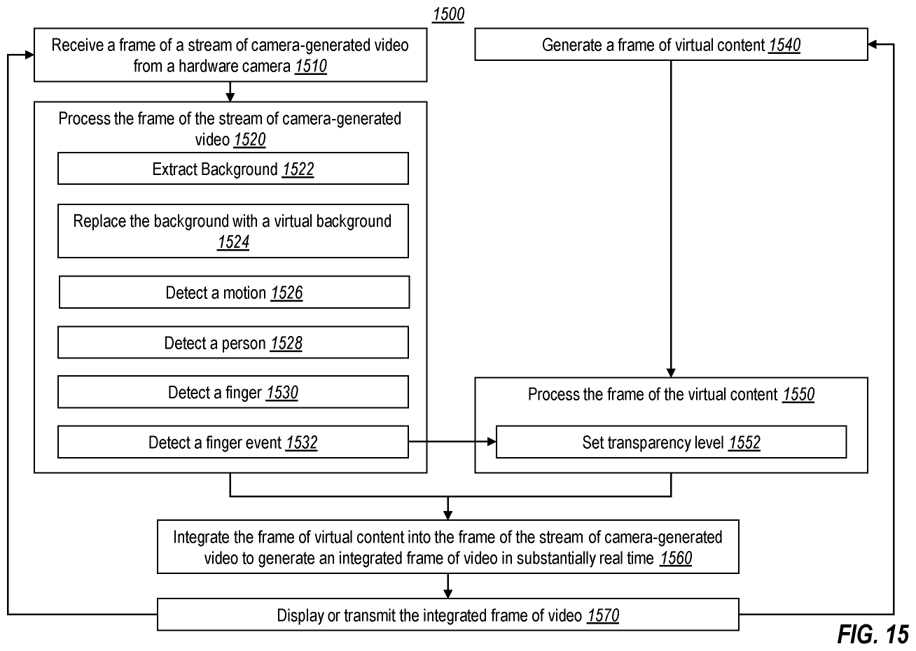

FIG. 15 is a flowchart of an example method 1500 for integrating each frame of virtual content into each frame of the stream of the camera-generated video, which corresponds to act 1440 of FIG. 14. The method 1500 includes receiving a frame of a stream of camera-generated video from a hardware camera (act 1510) and processing the frame of the stream of the camera-generated video (act 1520). The method 1500 further includes receiving a frame of virtual content from a multimedia file (act 1540) and processing the frame of virtual content (act 1550). The frame of virtual content is then integrated into the frame of the stream of the camera-generated video to generate an integrated frame of video in substantially real time (act 1560). The integrated frame of video is then displayed in a graphical user interface or transmitted over a network (act 1570).

In some embodiments processing the frame of the stream of the camera-generated video (act 1520) includes (but are not limited to) (1) extracting a static background in the frame of the stream of the camera-generated video (act 1522), (2) replacing the detected static background in the frame of the stream of the camera-generated video with a virtual background (act 1524), (3) detecting a motion in the frame of the stream of the camera-generated video (act 1526), (4) detecting a person in the frame of the stream of the camera-generated video (act 1528), (5) detecting a finger of the person in the frame of the stream of the camera-generated video (act 1530), and/or (6) detecting a finger event, in which the finger of the person is in an area where the frame of virtual content is integrated (act 1532).

In some embodiments, processing the frame of virtual content (act 1550) includes setting a transparency level of the frame of virtual content (act 1552). In some embodiments, in response to detecting a finger event, in which the finger of the detected person is in the area where the frame of virtual content is integrated (act 1532), the transparency level of the virtual content is set as semi-transparent (act 1552), such that both the finger of the person and the frame of virtual content are at least partially visible to users.

In some embodiments, integrating the frame of virtual content into the frame of the camera-generated video includes (1) overlaying the virtual content on top of the frame of camera-generated video, (2) overlaying the virtual content on top of the static background of the frame of camera-generated video, and/or (3) overlaying the detected person in the frame of camera-generated video on top of the virtual content. In some embodiments, the transparency level of the camera-generated content may also be adjusted. In some embodiments, processing the frame of the virtual content may also include (1) extracting a static background, (2) replacing the static background with a virtual background, (3) detecting a motion in the frame of the virtual content, (4) detecting a person in the frame of the virtual content, (5) detecting a finger in the frame of virtual content, and/or detecting a finger event in the frame of the virtual content.

For each incoming frame of the stream of the camera-generated video or virtual content, the acts 1510, 1520, 1540, 1550, 1560, 1570 may repeat again, such that an integrated stream of video is generated in substantially real time.

In the description and claims of the present application, each of the verbs, “comprise”, “include”, and “have”, and conjugates thereof, are used to indicate that the object or objects of the verb are not necessarily a complete listing of members, components, elements or parts of the subject or subjects of the verb.

Furthermore, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood and effected by those skilled in the art and practicing the claimed technology, from a study of the drawings, the technology, and the appended claims.

In the claims, the word “comprising” does not exclude other elements or steps, and the indefinite article “a” or “an” does not exclude a plurality. A single processor or other units may fulfill the functions of several items recited in the claims. The mere fact that certain measures are recited in mutually different dependent claims does not indicate that a combination of these measures can not be used to advantage.

The present technology is also understood to encompass the exact terms, features, numerical values or ranges, etc., if in here such terms, features, numerical values or ranges, etc. are referred to in connection with terms such as “about, ca., substantially, generally, at least” etc. In other words, “about 3” shall also comprise “3” or “substantially perpendicular” shall also comprise “perpendicular”. Any reference signs in the claims should not be considered as limiting the scope. The term of “in substantially real time” means that the integration of the virtual content into the camera-generated video stream is sufficiently fast, such that the possible delay of the integration process does not affect real time communication conducted over a network. Such delay may be fluctuating based on the computer's processing power, and the available hardware resources at the time when the process is performed. For example, in some cases, such delay is within a few seconds, a few milliseconds, a few microseconds, depending on the hardware.

Although the present embodiments have been described to a certain degree of particularity, it should be understood that various alterations and modifications could be made without departing from the scope of the invention as hereinafter claimed.

The following is a discussion of aspects of example operating environments for various embodiments of the invention. This discussion is not intended to limit the scope of the invention, or the applicability of the embodiments, in any way.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Computer system functionality can be enhanced by a computer systems' ability to be interconnected to other computer systems via network connections. Network connections may include, but are not limited to, connections via wired or wireless Ethernet, cellular connections, or even computer to computer connections through serial, parallel, USB, or other connections. The connections allow a computer system to access services at other computer systems and to quickly and efficiently receive application data from other computer systems.

Interconnection of computer systems has facilitated distributed computer systems, such as so-called “cloud” computer systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote-based service applications are prevalent. Such applications are hosted on public and private remote systems such as clouds and usually offer a set of web-based services for communicating back and forth with clients.

Many computers are intended to be used by direct user interaction with the computer. As such, computers have input hardware and software user interfaces to facilitate user interaction. For example, a modern general-purpose computer may include a keyboard, mouse, touchpad, camera, etc. for allowing a user to input data into the computer. In addition, various software user interfaces may be available.

Examples of software user interfaces include graphical user interfaces, text command line based user interfaces, function key or hot key user interfaces, and the like.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links that can be used to carry program code in the form of computer-executable instructions or data structures and which can be accessed by a general-purpose or special-purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Following are further example embodiments of the invention. These are presented only by way of example and are not intended to limit the scope of the invention in any way.

Embodiment 1. A computer system for real-time integrating virtual content into a live streaming video. The computer system includes one or more processors and one or more computer-readable hardware storage devices, having stored thereon computer-executable instructions that are structured such that, when executed by the one or more processors, configure the computer system to receive a stream of camera-generated video from a hardware camera, obtain virtual content from a multimedia file, and integrate the virtual content into the stream of the camera-generated video to generate an integrated stream of video. Integrating the virtual content into the stream of the camera-generated video includes integrating each frame of virtual content into each frame of the stream of the camera-generated video in substantially real time.

Embodiment 2. The computer system in embodiment 1, wherein integrating each frame of virtual content into each frame of the stream of the camera-generated video includes, for each frame of the stream of the camera-generated video and each frame of virtual content, receiving a frame of the stream of the camera-generated video from the hardware camera, receive a frame of virtual content from the multimedia file, integrating the frame of virtual content into the frame of the stream of the camera-generated video in substantially real time to generate an integrated frame of video, and displaying and/or transmitting the integrated frame of video.

Embodiment 3. The computer system in any of embodiments 1-2, wherein integrating each frame of virtual content into each frame of the stream of the camera-generated video further includes processing the frame of the stream of the camera-generated video, processing the frame of the virtual content, and integrating the processed frame of the virtual content into the processed frame of the stream of the camera-generated video.

Embodiment 4. The computer system in any of embodiments 1-3, wherein processing the frame of the stream of the camera-generated video comprises at least one of (1) extracting a static background in the frame of the stream of the camera-generated video, (2) replacing the static background with a virtual background, (3) detecting a motion in the frame of the stream of the camera-generated video, (4) detecting a person in the frame of the stream of the camera-generated video, (5) detecting a finger of the person in the frame of the stream of the camera-generated video, and/or (6) detecting an event, in which the finger of the person is in an area where the frame of virtual content is integrated.

Embodiment 5. The computer system in any of embodiments 1-4, wherein processing the frame of the virtual content comprises: in response to detecting the finger event, in which the finger of the person is in the area where the frame of virtual content is integrated, setting a transparency level of the frame of the virtual content to semi-transparent, such that the finger of the person and the frame of the virtual content are both at least partially visible.

Embodiment 6. The computer system in any of embodiments 1-5, wherein integrating the processed frame of the virtual content into the processed frame of the stream of the camera-generated video includes at least one of: (1) overlaying the frame of the virtual content on top of the frame of the stream of the camera-generated video, (2) overlaying the frame of the virtual content on top of the static background of the frame of the stream of the camera-generated video, and/or (3) overlaying the detected person in the frame of the stream of the camera-generated video on top of the frame of the virtual content.

Embodiment 7. The computer system in any of embodiments 1-6, wherein the multimedia file includes at least one of an image file, a video file, a text file, a presentation file, a three-dimensional file, and/or a web page.

Embodiment 8. The computer system in any of embodiments 1-7, the computer system further configured to display a first graphical user interface (GUI), including a plurality of controls configured to control the integration of virtual content into the stream of the camera-generated video.

Embodiment 9. The computer system in any of embodiment 8, the plurality of controls are configured to adjust a size, a location, and/or an angle of rotation of the virtual content relative to the stream of the camera-generated video.

Embodiment 10. The computer system in any of embodiments 8-9, the first GUI includes a floating widget that is separate from a second GUI configured to display the stream of the camera-generated video, the virtual content, and/or the integrated stream of video.

Embodiment 11. The computer system in embodiment 10, wherein the first GUI is configured to allow a user to create a project, link a series of multimedia files in the project, and/or store settings associated with each of the series of multimedia files in the project. The first GUI includes a visualization configured to display a series of thumbnails corresponding to the series of multimedia files. In response to selecting at least one thumbnail among the series of thumbnails, the computer system is configured to integrate virtual content corresponding to the selected at least one thumbnail into the stream of the camera-generated video based on the settings associated with the corresponding multimedia file and display the stream of the camera-generated video integrated with virtual content in the second GUI.

Embodiment 12. The computer system in embodiment 11, wherein each multimedia file corresponds to a URL or a path associated with a location where the multimedia file is stored, and the project stores a series of URLs or paths corresponding to the series of multimedia files in a list.

Embodiment 13. The computer system in embodiment 12, wherein in response to receiving a user input, dragging a multimedia file or a webpage into the visualization, the computer system is configured to save a path corresponding to the multimedia file or a URL corresponding to the web page in the project; generate a thumbnail corresponding to the multimedia file or the webpage, and display the thumbnail in the visualization.

Embodiment 14. The computer system in embodiment 13, wherein one or more controls are superimposed on each thumbnail and configured to control integration of virtual content corresponding to the thumbnail.

Embodiment 15. The computer system in any of embodiments 12-14, wherein each project includes one or more chapters, and each chapter includes one or more items, each of which corresponds to a multimedia file.

Embodiment 16. The computer system in any of embodiments 1-15 is further configured to record the integrated stream of video as a video file.

Embodiment 17. The computer system in any of embodiments 1-16 is further configured to stream the integrated stream of video via a network conference application.

Embodiment 18. A method implemented at a computer system for integrating virtual content into a live streaming video in substantially real time. The method includes receiving a stream of camera-generated video from a hardware camera, obtaining virtual content from a multimedia file, and integrating the virtual content into the stream of the camera-generated video to generate an integrated stream of video in substantially real time. Integrating the virtual content into the stream of the camera-generated video includes integrating each frame of virtual content into each frame of the stream of the camera-generated video in substantially real time. Integrating each frame of virtual content into each frame of the stream of the camera-generated video includes, for each frame of the stream of the camera-generated video and each frame of the virtual content, receiving a frame of the stream of the camera-generated video from the hardware camera; receiving a frame of virtual content from the multimedia file; integrating the frame of virtual content into the frame of the stream of the camera-generated video in substantially real time to generate an integrated frame of video; and displaying or transmitting the integrated frame of video.

Embodiment 19. The method in embodiment 18, wherein integrating each frame of virtual content into each frame of the stream of the camera-generated video further includes: processing the frame of the stream of the camera-generated video; processing the frame of the virtual content; and integrating the processed frame of the virtual content into the processed frame of the stream of the camera-generated video. Processing the frame of the stream of the camera-generated video includes at least one of: (1) extracting a static background in the frame of the stream of the camera-generated video; (2) replacing the static background with a virtual background; (3) detecting a motion in the frame of the stream of the camera-generated video; (4) detecting a person in the frame of the stream of the camera-generated video; (5) detecting a finger of the person in the frame of the stream of the camera-generated video; and/or (6) detecting a finger event, in which the finger of the person is in an area where the frame of virtual content is integrated. Processing the frame of the virtual content includes: in response to detecting the finger event, in which the finger of the person is in the area where the frame of virtual content is integrated, setting a transparency level of the frame of the virtual content to semi-transparent, such that the finger of the person and the frame of virtual content are both at least partially visible.

What is claimed is:

1. A computer system for real-time integrating virtual content into a live streaming video, comprising:
one or more processors; and
one or more computer-readable hardware storage devices having stored thereon computer-executable instructions that are structured such that, when executed by the one or more processors, configure the computer system to perform at least:
receive a stream of a camera-generated video from a hardware camera;
obtain virtual content from a multimedia file;
integrate the virtual content into the stream of the camera-generated video to generate an integrated stream of video in substantially real time, wherein integrating the virtual content into the stream of the camera-generated video comprising integrating each frame of virtual content into each frame of the stream of the camera-generated video in substantially real time.

2. The computer system of claim 1, wherein integrating each frame of virtual content into each frame of the stream of the camera-generated video comprises,
for each frame of the stream of the camera-generated video and each frame of virtual content,
receiving a frame of the stream of the camera-generated video from the hardware camera;
receiving a frame of virtual content from the multimedia file;
integrating the frame of virtual content into the frame of the stream of the camera-generated video in substantially real time to generate an integrated frame of video; and
displaying or transmitting the integrated frame of video.

3. The computer system of claim 2, wherein integrating each frame of virtual content into each frame of the stream of the camera-generated video further comprises:
processing the frame of the stream of the camera-generated video;
processing the frame of the virtual content; and
integrating the processed frame of the virtual content into the processed frame of the stream of the camera-generated video.

4. The computer system of claim 3, wherein processing the frame of the stream of the camera-generated video comprises at least one of:
(1) extracting a static background in the frame of the stream of the camera-generated video;
(2) replacing the static background with a virtual background;
(3) detecting a motion in the frame of the stream of the camera-generated video;
(4) detecting a person in the frame of the stream of the camera-generated video;
(5) detecting a finger of the person in the frame of the stream of the camera-generated video; or
(6) detecting a finger event, in which the finger of the person is in an area where the frame of virtual content is integrated.

5. The computer system of claim 4, wherein processing the frame of the virtual content comprises:
in response to detecting the finger event, in which the finger of the person is in the area where the frame of virtual content is integrated, setting a transparency level of the frame of the virtual content to semi-transparent, such that the finger of the person and the frame of virtual content are both at least partially visible.

6. The computer system of claim 4, wherein integrating the processed frame of the virtual content into the processed frame of the stream of the camera-generated video comprises at least one of:
(1) overlaying the frame of the virtual content on top of the frame of the stream of the camera-generated video;
(2) overlaying the frame of the virtual content on top of the static background of the frame of the stream of the camera-generated video; or
(3) overlaying the detected person in the frame of the stream of the camera-generated video on top of the frame of the virtual content.

7. The computer system of claim 1, wherein the multimedia file comprises at least one of an image file, a video file, a text file, a presentation file, a three-dimensional file, or a web page.

8. The computer system of claim 1, the computer system further configured to display a first graphical user interface (GUI) including a plurality of controls configured to control the integration of virtual content into the stream of the camera-generated video.

9. The computer system of claim 8, wherein the plurality of controls are configured to adjust a size, a location, or an angle of rotation of virtual content relative to the stream of the camera-generated video.

10. The computer system of claim 8, wherein the computer system is further configured to display a second GUI configured to display the stream of the camera-generated video, the virtual content, or the integrated stream of video, and
the first GUI comprises a floating widget that is separate from the second GUI.

11. The computer system of claim 10, wherein:
the first GUI is configured to allow a user to create a project, link a series of multimedia files in the project, or store settings associated with each of the series of multimedia files in the project;
the first GUI comprises a visualization configured to display a series of thumbnails corresponding to the series of multimedia files;
in response to selecting at least one thumbnail among the series of thumbnails, the computer system is configured to:
integrate virtual content corresponding to the selected at least one thumbnail into the stream of the camera-generated video based on the settings associated with the corresponding multimedia file; and
display the stream of the camera-generated video integrated with virtual content in the second GUI.

12. The computer system of claim 11, wherein:
each multimedia file corresponds to a URL or a path associated with a location where the multimedia file is stored, and
the project stores a series of URLs or paths corresponding to the series of multimedia files in a list.

13. The computer system of claim 12, wherein in response to receiving a user input dragging a multimedia file or a webpage into the visualization, the computer system is configured to:
save a path corresponding to the multimedia file or a URL corresponding to the webpage in the project;
generate a thumbnail corresponding to the multimedia file or the webpage; and
display the thumbnail in the visualization.

14. The computer system of claim 13, wherein one or more controls are superimposed on each thumbnail and configured to control integration of virtual content corresponding to the thumbnail.

15. The computer system of claim 12, wherein:
each project comprises one or more chapters; and
each chapter comprises one or more items, each of which corresponds to a multimedia file.

16. The computer system of claim 1, the computer system further configured to record the integrated stream of video as a video file.

17. The computer system of claim 1, the computer system further configured to stream the integrated stream of video via a network conference application.

18. A method implemented at a computer system for real-time integrating virtual content into a live streaming video, the method comprising:
receiving a stream of camera-generated video from a hardware camera;
obtaining virtual content from a multimedia file; and
integrating the virtual content into the stream of the camera-generated video to generate an integrated stream of video in substantially real time, wherein integrating the virtual content into the stream of the camera-generated video comprising integrating each frame of virtual content into each frame of the stream of the camera-generated video in substantially real time,
wherein integrating each frame of virtual content into each frame of the stream of the camera-generated video comprises,
for each frame of the stream of the camera-generated video and each frame of the virtual content,
receiving a frame of the stream of the camera-generated video from the hardware camera;
receiving a frame of virtual content from the multimedia file;
integrating the frame of virtual content into the frame of the stream of the camera-generated video in substantially real time to generate an integrated frame of video; and
displaying or transmitting the integrated frame of video.

19. The method of claim 18, wherein integrating each frame of virtual content into each frame of the stream of the camera-generated video further comprises:
processing the frame of the stream of the camera-generated video;
processing the frame of the virtual content; and
integrating the processed frame of the virtual content into the processed frame of the stream of the camera-generated video,
wherein processing the frame of the stream of the camera-generated video comprises at least one of:
(1) extracting a static background in the frame of the stream of the camera-generated video;
(2) replacing the static background with a virtual background;
(3) detecting a motion in the frame of the stream of the camera-generated video;
(4) detecting a person in the frame of the stream of the camera-generated video;
(5) detecting a finger of the person in the frame of the stream of the camera-generated video; or
(6) detecting a finger event, in which the finger of the person is in an area where the frame of virtual content is integrated,
wherein processing the frame of the virtual content comprises:
in response to detecting the finger event, in which the finger of the person is in the area where the frame of virtual content is integrated, setting a transparency level of the frame of the virtual content to semi-transparent, such that the finger of the person and the frame of virtual content are both at least partially visible.

20. A computer program product comprising one or more hardware storage devices having stored thereon computer-executable instructions that are structured such that, when the computer-executable instructions are executed by one or more processors of a computer system, the computer-executable instructions cause the computer system to perform at least:
receive a stream of camera-generated video from a hardware camera;
obtain virtual content from a multimedia file; and
integrate the virtual content into the stream of the camera-generated video to generate an integrated stream of video in substantially real time, wherein integrating the virtual content into the stream of the camera-generated video comprising integrating each frame of virtual content into each frame of the stream of the camera-generated video in substantially real time,
wherein integrating each frame of virtual content into each frame of the stream of the camera-generated video comprises,
for each frame of the stream of the camera-generated video and each frame of the virtual content,
receiving a frame of the stream of the camera-generated video from the hardware camera;
receiving a frame of virtual content from the multimedia file;
integrating the frame of virtual content into the frame of the stream of the camera-generated video in substantially real time to generate an integrated frame of video; and
displaying or transmitting the integrated frame of video.
